(19) United States
(12) Patent Application Publication
(10) Pub. No.: US 2013/0322472 A1
(43) Pub. Date: Dec. 5, 2013

(54) WAVELENGTH SELECTIVE AND TUNABLE LASER DEVICE

(71) Applicant: Ruolin Li, Milpitas, CA (US)

(72) Inventor: Ruolin Li, Milpitas, CA (US)

(73) Assignee: Mars Technology

(21) Appl. No.: 13/482,428

(22) Filed: May 29, 2012

(51) Int. Cl. H01S 3/10

(52) U.S. Cl. 372/20

(57) ABSTRACT

Exemplary embodiments provide wavelength selective and tunable laser devices and a method for tuning the laser devices. An exemplary laser device, which can be operated in a single-wavelength lasing mode at a selectable and tunable lasing wavelength, includes a multi-mode laser, a feedback portion, and a wavelength tuning structure. The laser generates an optical emission having a spectrum that peaks at a plurality of discrete wavelengths. The feedback portion includes an optical etalon arranged to provide wavelength selective feedback to the laser to generate a beam of laser light at a lasing wavelength selected from the plurality of discrete wavelengths. The wavelength tuning structure provides tuning of the lasing wavelength by locally adjusting a refractive index of the channel waveguide to adjust the spectrum of the optical emission, where the wavelength tuning structure adjusts the spectrum of the optical emission to overlap a transmission spectrum of the etalon at the lasing wavelength.

### TECHNICAL FIELD

The present application is directed to a wavelength selective and tunable laser device, and in particular, to a laser device which can be operated in a single-wavelength lasing mode at a selectable and tunable wavelength.

### BACKGROUND

Wavelength-division multiplexing (WDM) has become widespread in fiber optic communication systems. A WDM transponder includes a laser, a modulator, a receiver, and associated electronics. As the light source of choice for WDM transmission systems, distributed feedback (DFB) lasers have been used widely because they are easy to fabricate and handle and are highly reliable. In DFB lasers, a diffraction grating is formed over the entire region of an active resonator, and a stable single-mode lasing can be obtained at a fixed wavelength. Direct modulation on DFB lasers is also possible for low data rate applications.

However, DFB lasers are not capable of tuning over a wide range of wavelengths, and thus a WDM transmission system is constituted by using lasers of different wavelengths for each International Telecommunication Union (ITU) grid. Therefore, it is necessary to use different lasers for each wavelength, which results in increased cost for wavelength management and requires a surplus stock of laser backups for dealing with breakdowns, etc.

To overcome such shortcoming of current DFB lasers and to achieve single-mode operation with a wide range of wavelengths, tunable lasers have been demanded and developed. A single-mode tunable laser can serve as a back-up for multiple channels or wavelengths so that fewer WDM transponders are needed in stock for spare parts. Tunable lasers can also provide flexibility at multiplexing locations, where wavelengths can be added and dropped from fibers as needed. Accordingly, tunable lasers can help carriers effectively manage wavelengths throughout a fiber optics network.

### SUMMARY

According to various embodiments, the present teachings include a laser device operable in a single-wavelength lasing mode at a selectable and tunable lasing wavelength. The laser device can include a multi-mode laser, a feedback portion, and a wavelength tuning structure. The laser can be a Fabry-Perot laser, and can include a channel waveguide with a first reflective coating and a second reflective coating arranged at opposite ends of the channel waveguide, where the laser generates an optical emission having a spectrum that peaks at a plurality of discrete wavelengths. The feedback portion can include an optical etalon and a reflective surface arranged to provide wavelength-selective feedback to the laser to generate a beam of laser light at a lasing wavelength selected from the plurality of discrete wavelengths. The wavelength tuning structure can be disposed proximate to the laser to provide tuning of the lasing wavelength by locally adjusting a refractive index of the channel waveguide to adjust the spectrum of the optical emission, where the wavelength tuning structure can adjust the spectrum of the optical emission to overlap a transmission spectrum of the etalon at the lasing wavelength.

The transmission spectrum of the etalon is arranged to exhibit comb-like maxima, and can act as additional wavelength filter in the feedback portion and operate with the reflective surface to provide external feedback to the laser with a comb-like reflection over a broad range of wavelengths. The optical emission generated by the laser can be reflected between the first reflective coating of the channel waveguide at one side and the reflective surface of the feedback portion at the other side to generate coherent resonance to create an emitted beam of laser light.

With the longitudinal mode spacing of the laser's optical emission and the free spectral range of the etalon's maxima transmission being different, typically only one emission peak of the laser and transmission maximum of the etalon can be aligned in correspondence to a wavelength at a time, to produce a laser emission at that single wavelength. Magnitude of the optical emission at the laser's other emission peaks or the etalon's other transmission maxima is not sufficient to cause lasing. Because single-mode lasing can be tuned to occur only at a peak transmission wavelength of the etalon for such a wavelength selective and tunable laser device, when the etalon is compatible with or otherwise meets the channel wavelength requirement of International Telecommunication Union (ITU) grid for telecommunication, the wavelength of the laser device can be pre-defined to be ITU-compatible without requiring external wavelength control or reference during operation. Furthermore, the refractive index of the laser and/or the optical etalon can be adjusted to generate step, quasi-continuous, or continuous tuning of the lasing wavelength of the laser device. When both the laser and the etalon are tuned to provide a low-loss window at any time and thereby generate lasing condition, the output of such laser device is wavelength selectable and tunable.

According to various embodiments, the present teachings also include a laser device operable in a single-wavelength lasing mode at a selectable and tunable lasing wavelength. The laser device can include a multi-mode laser, a feedback portion, and a wavelength tuning structure. The laser can be a Fabry-Perot laser and can generate an optical emission having a spectrum that peaks at a plurality of discrete wavelengths. The feedback portion can include an optical etalon and a reflective surface arranged to provide wavelength selective feedback to the laser to generate a beam of laser light at a lasing wavelength selected from the plurality of discrete wavelengths. The wavelength tuning structure can be disposed proximate to the etalon to provide tuning of the lasing wavelength by locally adjusting a refractive index of the etalon to adjust a transmission spectrum of the optical emission, where the wavelength tuning structure adjusts the transmission spectrum of the etalon to overlap the spectrum of the optical emission of the laser at the lasing wavelength.

According to various embodiments, the present teachings further include a method for tuning a laser device operable in a single-wavelength lasing mode. In this method, an optical emission from a multi-mode laser of the laser device can be passed to a feedback portion of the laser device, where a spectrum of the optical emission peaks at a plurality of discrete wavelengths. The laser can be a Fabry-Perot laser and can include a channel waveguide. A portion of the optical emission can be reflected from the feedback portion back to the laser, the feedback portion comprising an optical etalon and a reflective surface, where the reflected portion of the optical emission includes the optical emission at one or more peak transmission wavelengths of a transmission spectrum of the etalon. A lasing wavelength of the laser device can be tuned by locally adjusting a refractive index of the channel waveguide to adjust the spectrum of the optical emission.

Additional embodiments and advantages of the disclosure will be set forth in part in the description which follows, and can be learned by practice of the disclosure. The embodiments and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIGS. 1A and 1B are perspective top and side views, respectively, of an exemplary wavelength selective and tunable laser device, in accordance with various embodiments of the present teachings;

FIGS. 2A and 2B show the comb-like transmission spectrum of an etalon (dashed curve) and discrete lasing lines of an FP laser chip (solid curve), in accordance with various embodiments of the present teachings;

FIG. 3 is a perspective top view of an exemplary wavelength selective and tunable laser device, in accordance with various embodiments of the present teachings; and

FIGS. 4A and 4B are perspective top and side views, respectively, of an exemplary wavelength selective and tunable laser device, in accordance with various embodiments of the present teachings.

It should be noted that some details of the figures have been simplified and are drawn to facilitate understanding of the present teachings rather than to maintain strict structural accuracy, detail, and scale.

### DESCRIPTION OF THE EMBODIMENTS

Reference will now be made in detail to the exemplary embodiments of the present teachings, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the present teachings may be practices. These embodiments are described in sufficient details to enable those skilled in the art to practice the present teachings and it is to be understood that other embodiments may be utilized and that electrical, mechanical, logical and structural changes can be made to the embodiments without departing from the spirit and scope of the present teachings. The following detailed description is, therefore, not to be taken in a limiting sense and the scope of the present teachings is defined by the appended claims and their equivalents.

Generally, various embodiments of the present teachings describe a wavelength selective and tunable laser device comprising an active Fabry-Perot (FP) laser chip for photon generation and gain and a micro-optical external cavity for feedback. The FP laser chip can be a multi-mode laser chip, and thus can generate an optical emission having a spectrum that peaks at a series of discrete wavelengths. The external cavity can include an optical lens, an etalon, and a reflector. The etalon and the reflector can be placed together in close proximity and work together to provide wavelength-selective feedback to the existing lasing spectrum of the FP laser chip. By providing additional wavelength selective feedback, the etalon and the reflector can enable the laser device to operate in a single-wavelength lasing mode at a selectable and tunable wavelength.

The peak wavelengths of the FP laser chip's optical emission and their spacing are determined by the length and refractive index of the FP laser chip. The FP laser chip can be mounted on or otherwise disposed near a temperature controller, which can change the temperature and thus the refractive index of the FP laser chip through a thermal-optical effect. The periodic wavelengths of the FP laser chip's peak emission can be adjusted by controlling the temperature and thus the refractive index of the FP laser chip.

The optical emission of the FP laser chip, after being collimated by the optical lens, passes through the etalon with minimal loss only when at least one of its peak wavelengths overlaps with that of at least one of the transmission maxima of the etalon. The etalon, located between the FP laser chip and the reflector, has maxima transmission at periodic wavelengths determined by its optical thickness and refractive index. The etalon can be mounted on or otherwise disposed near a temperature controller, which can change the temperature and thus the refractive index of the etalon through a thermal-optical effect. The wavelengths of the etalon's transmission maxima can be adjusted by controlling the temperature of the etalon.

After passing through the etalon, the optical emission hits the reflector and is sent back along same path to the FP laser chip for amplification. By choosing the reflectivity at the facets of the FP chip and at the reflector of the external cavity, a new single-mode resonance cavity can be formed between the far side facet of the FP laser chip and the reflector to create a newly emitted laser beam at a selectable and tunable wavelength. For such an external cavity laser, single-mode lasing occurs only at one of the maxima transmission wavelengths of the etalon. When the etalon is designed to meet the channel wavelength requirement of International Telecommunication Union (ITU) grid for telecommunication, the wavelength of the laser device can be pre-defined for ITU-compatible operation without requiring external wavelength control or reference.

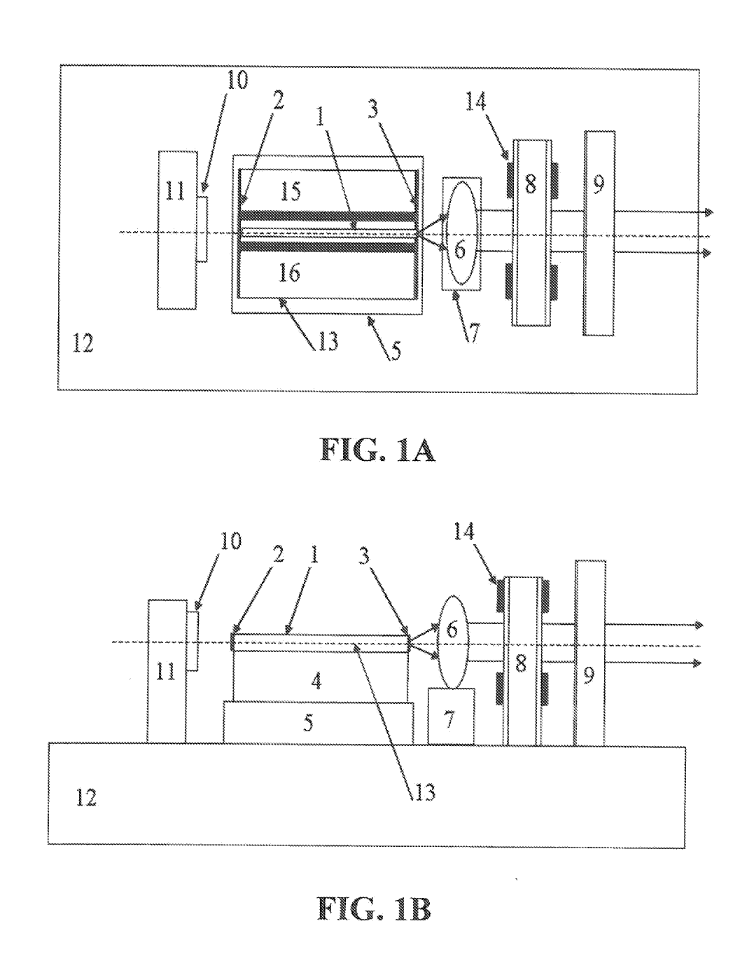

FIGS. 1A and 1B are perspective top and side views, respectively, of an exemplary wavelength selective and tunable laser device having a micro-optical assembly-based external cavity laser that comprises an FP laser chip 13, an optical lens 6, an optical etalon 8, and a partial reflector 9. FP laser chip 13 can be made of a compound semiconductor material, and can have a highly reflective (HR) or partially reflective (PR) coating on a facet 2 and a PR coating on another facet 3. FP laser chip 13 can be placed on a mount 4, which can be made of any suitable material such as ceramic, metal, plastic, etc. Mount 4, in turn, can be placed on a thermoelectric cooler (TEC) 5 or any other suitable local temperature controller. Alternatively, FP laser chip 13 can be placed directly on or otherwise adjacent to TEC 5. Lens 6 can be placed on a lens mount 7.

According to various embodiments of the present teachings and as shown in FIGS. 1A and 1B, photons can be generated and amplified in a channel waveguide 1 region of FP laser chip 13. FP laser chip 13 as a gain is capable of generating an optical emission peaking at multiple wavelengths when, for example, electrical current is applied via electrodes 15, 16 disposed along or otherwise proximate to channel waveguide 1. The peak wavelengths and their spacing are determined by the gain spectrum, refractive index of the chip material, and the length of FP laser chip 13. The wavelength separation between the neighboring laser lines is called longitudinal mode spacing (LMS).

According to various embodiments of the present teachings and as shown in FIGS. 1A and 1B, the optical emission exiting facet 3 is collimated by lens 6, transmitted by etalon 8, and then transmitted or reflected by partial reflector 9. Lens 6, etalon 8, and partial reflector 9 form an external cavity to provide wavelength-selective feedback for the laser device. A single-mode resonance path can be established between reflective facet 2 of FP laser chip 13 and partial reflector 9 of the external cavity for the laser device. Partial reflector 9 can also serve as an output coupler for the new laser beam to exit.

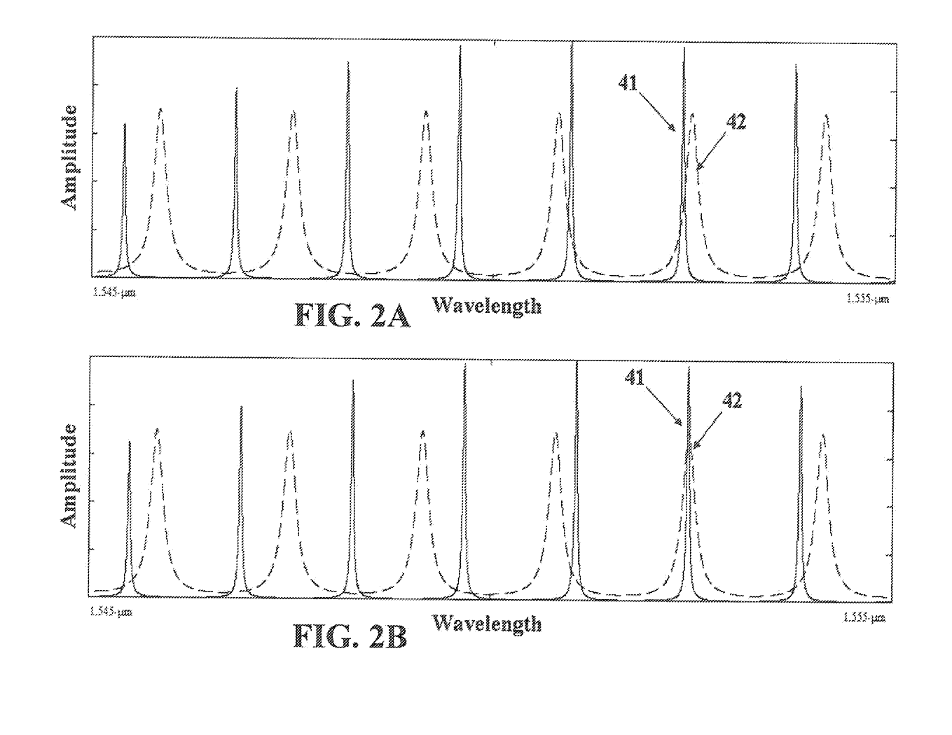

As shown in FIGS. 2A and 2B, etalon 8 can have transmission maxima (shown in dashed line) at a series of periodically distributed wavelengths determined by its refractive index and thickness. The wavelength spacing between neighboring transmission maxima in the transmission spectrum of etalon 8 is called free spectral range (FSR). With the LMS of FP laser chip 13 and the FSR of etalon 8 being different, the optical emission (shown in solid line) of FP laser chip 13, which also has evenly distributed wavelengths, can pass etalon 8 with minimal loss only when it overlaps in wavelength with at least one of the transmission maxima of etalon 8. Either the LMS of the optical emission of FP laser chip 13 or the FSR of etalon 8 can be pre-defined so that only one overlap exists between the transmission spectrum of etalon 8 and the emission spectrum of FP laser chip 13 at a time within the wavelength range of interest. Such an overlap can be achieved by tuning FP laser chip 13 through a thermal-optical effect, i.e., using a temperature controller or a heat pump such as TEC 5, placed below or otherwise proximate to FP laser chip 13, to change the refractive index of FP laser chip 13 by adjusting the temperature of channel waveguide 1.

When the emission spectrum of FP laser chip 13 does not overlap with the transmission spectrum of etalon 8, as shown for example in FIG. 2A, the optical emission of FP laser chip 13, including that at a peak emission wavelength 41, would not pass etalon 8 with minimal loss. By adjusting the refractive index of FP laser chip 13, the emission spectrum of FP laser chip 13 can be tuned to overlap with the transmission spectrum of etalon 8, as shown for example in FIG. 2B, the optical emission of FP laser chip 13 at peak emission wavelength 41 would pass etalon 8 with minimal loss because it overlaps with a peak transmission wavelength 42 of etalon 8, At the overlapped wavelength, the optical emission from FP laser chip 13 can pass through etalon 8 with minimal loss to reach partial reflector 9, where some of the optical emission is sent back to the cavity along the same path to FP laser chip 13 for amplification. Because the optical emission of FP laser chip 13 achieves maximum gain at the overlapped wavelength, and the magnitude of gain in the other peak wavelengths of the optical emission are not sufficient, lasing for the laser device would occur only at the overlapped wavelength.

In various embodiments, the wavelength selective and tunable laser device can lase at a single wavelength, in contrast to the multi-wavelength emission of FP laser chip 13. By tuning FP laser chip 13 through temperature change, for example, by adjusting the temperature of TEC 5, the overlap can be achieved at a chosen peak transmission wavelength 42 of etalon 8 each time in a controlled manner, so the laser output by the laser device is wavelength selective. Accordingly, the wavelength of the laser device's emitted laser beam can be selected and/or tuned by using the temperature controller to locally adjust the temperature and thus the refractive index of channel waveguide 1. Also, because single-mode lasing happens only at a peak transmission wavelength (e.g., peak transmission wavelength 42) of etalon 8, the laser device can be pre-defined to be ITU-compatible if etalon 8 is designed to have peak transmission wavelengths (i.e., transmission maxima) and wavelength separation that match the channel wavelength requirement of ITU grid for telecommunication, without the need for external wavelength control or reference during operation.

According to various embodiments and as shown in FIGS. 1A and 1B, local electrode heaters 14 can be built around or otherwise in proximity of etalon 8, and like the emission spectrum of FP laser chip 13, transmission spectrum of etalon 8 can also be tuned through a thermal-optical effect. For example, by passing current through local electrode heaters 14, the temperature and thus the refractive index and the transmission spectrum of etalon 8 can be locally adjusted. Accordingly, the wavelength of the laser device's emitted laser beam can also be selected and/or tuned by using local electrode heaters 14 to locally adjust the temperature and thus the refractive index of etalon 8. In various embodiments, both FP laser chip 13 and etalon 8 can be tuned, either independently or in a synchronized manner, to achieve an overlap between the transmission spectrum of etalon 8 and the emission spectrum of FP laser chip 13 at a target wavelength.

The whole external cavity laser assembly of the wavelength selective and tunable laser device can be placed on a large TEC 12 to maintain a constant temperature condition for the laser device under variable environments. Very little light of less than a few percent gets transmitted through the highly reflective facet 2 of FP laser chip 13 and can be detected by an optical monitor, such as a photo-detector 10, placed on a sub-mount 11, and the detection can be used as feedback for laser output power monitoring.

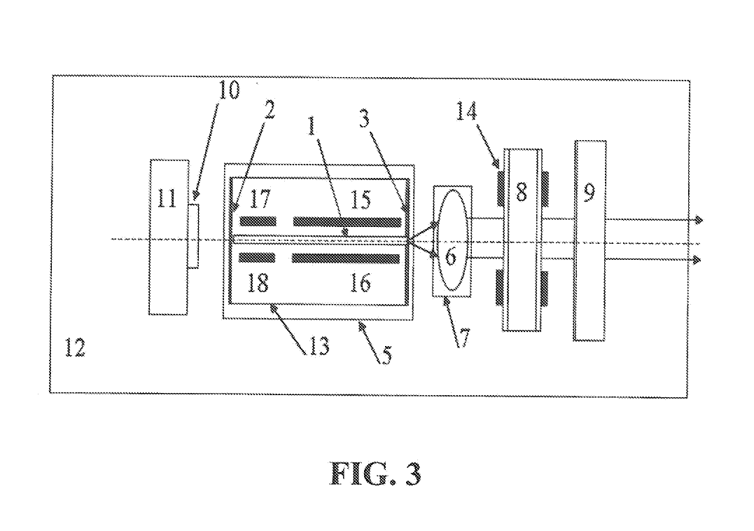

In further embodiments and as shown in FIG. 3, a phase control portion can be implemented in FP laser chip 13 by incorporating two electrodes 17, 18 on opposing sides of channel waveguide 1. The phase control portion can alter the refractive index of channel waveguide 1 to change the wavelength and/or phase of the photons for lasing condition. For example, the phase control portion can alter the refractive index of channel waveguide 1 through a thermal-optical effect by locally heating channel waveguide 1 using electrodes 17, 18, and thus altering the refractive index of channel waveguide I. Additionally or alternatively, the phase control portion can alter the refractive index of channel waveguide 1 through an electrical-optical effect, where the refractive index of channel waveguide 1 is changed by carrier injection upon applying electrical current to electrodes 17, 18.

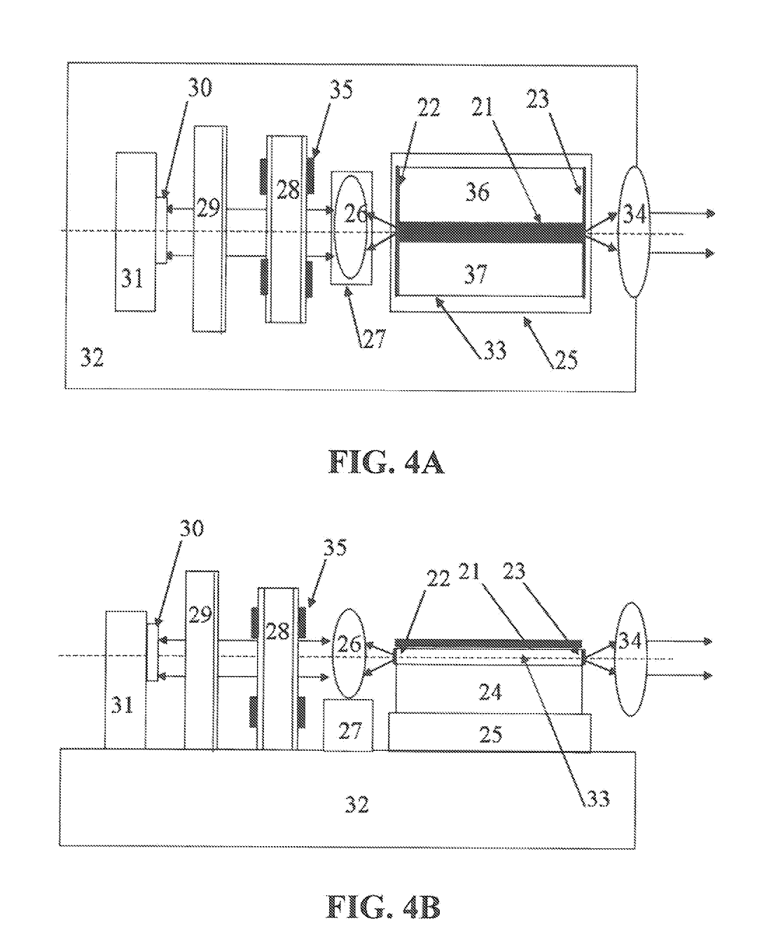

In additional embodiments and as shown in FIGS. 4A and 4B, an exemplary wavelength selective and tunable laser device can comprise an FP laser chip 33, an optical lens 26, an optical etalon 28, and a high reflector 29. FP laser chip 33 can have a PR coating on a facet 22 and the same or a different PR coating on another facet 23. FP laser chip 33 can be placed on a mount 24, which in turn can be placed on a TEC 25 or any other suitable local temperature controller. Alternatively, FP laser chip 33 can be placed directly on or otherwise adjacent to TEC 25. Lens 26 can be placed on a lens mount 27. The laser device's external cavity can comprise lens 26, an etalon 28, and high reflector 29. In the arrangement as shown in FIGS. 4A and 4B, the resonance round-trip cavity of the laser device is between high reflector 29 and facet 23 of FP laser chip 33. The laser beam can exit from facet 23 and be collimated by lens 34 for output. Lens 34 can also serve as an output coupler for the laser beam. The whole external cavity laser assembly of the laser device can be placed on a large TEC 32 to maintain a constant temperature condition for the laser device under variable environments. Very little light of less than a few percent, gets transmitted through high reflector 29 and can be detected by an optical monitor, such as a photo-detector 30, placed on a sub-mount 31, and the detection can be used as feedback for laser output power monitoring.

According to various embodiments of the present teachings and as shown in FIGS. 4A and 4B, photons can be generated and amplified in a channel waveguide 21 region of FP laser chip 33. FP laser chip 33 as a gain is capable of generating an optical emission peaking at multiple wavelengths when, for example, electrical current is applied via electrodes 36, 37 disposed along or otherwise proximate to channel waveguide 21. The wavelengths and their spacing are determined by the gain spectrum, refractive index of the chip material, and the length of FP laser chip 33.

For example, the emission spectrum of FP laser chip 33 can be tuned through a thermal-optical effect, i.e., using a temperature controller or a heat pump such as TEC 25, placed below or otherwise proximate to FP laser chip 33, to change the refractive index of FP laser chip 33 by adjusting the temperature of channel waveguide 21. The emission spectrum of FP laser chip 33 can also be tuned through an electrical-optical effect, where the refractive index of channel waveguide 21 is changed by carrier injection. Transmission spectrum of etalon 28 can be tuned through a thermal-optical effect. For example, by passing current through local electrode heaters 35, the temperature and thus the refractive index and the transmission spectrum of etalon 28 can be locally adjusted. Accordingly, the wavelength of the laser device's emitted laser beam can also be selected and/or tuned by using local electrode heaters 35 to locally adjust the temperature and thus the refractive index of etalon 28. In various embodiments, both FP laser chip 33 and etalon 28 can be tuned, either independently or in a synchronized manner, to achieve an overlap between the transmission spectrum of etalon 28 and the emission spectrum of FP laser chip 33 at a target wavelength. Wavelength selection, single-wavelength operation, and wavelength tuning can be achieved in a similar way by aligning the emission spectrum of FP laser chip 33 and the transmission spectrum of etalon 28 as discussed supra.

In general, the wavelength selective and tunable laser device can provide wavelength selection by matching the spectral responses of a multi-mode laser chip (e.g., FP laser chip 13 or 33) and an optical etalon (e.g., etalon 8 or 28). Advantages of such a laser device includes, inter alia, that there are no moving parts and that no complicated semiconductor material re-growth is required to form the laser device; the feedback portion of the laser device, which can include a micro-optical assembly, can easily be self-aligned on a mount platform; the laser device could achieve a very small form factor, so it can be assembled to fit a standard laser optical package format (e.g., TO56) widely used in optical communications; with its built-in optical etalon, lasing wavelength can be pre-defined in a look-up table, so no external wavelength monitoring and reference is needed in applications such as telecommunications; and with an FP laser chip of certain length being used, the laser device can be modulated directly for high data rate applications without needing an external modulator.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the workpiece, regardless of the orientation of the workpiece.

What is claimed is:

1. A laser device operable in a single-wavelength lasing mode at a selectable and tunable lasing wavelength, comprising:
a multi-mode laser comprising a channel waveguide having a first reflective coating and a second reflective coating arranged at opposite ends of the channel waveguide, wherein the laser generates an optical emission having a spectrum that peaks at a plurality of discrete wavelengths;
a feedback portion comprising an optical etalon and a reflective surface arranged to provide wavelength selective feedback to the laser to generate a beam of laser light at a lasing wavelength selected from the plurality of discrete wavelengths; and
a wavelength tuning structure disposed proximate to the laser to provide tuning of the lasing wavelength by locally adjusting a refractive index of the channel waveguide to adjust the spectrum of the optical emission,
wherein the wavelength tuning structure adjusts the spectrum of the optical emission to overlap a transmission spectrum of the optical etalon at the lasing wavelength.

2. The laser device of claim 1, wherein the laser comprises a Fabry-Perot laser.

3. The laser device of claim 1, wherein the wavelength tuning structure comprises one or more heat pumps disposed proximate to the channel waveguide of the laser to adjust the spectrum of the optical emission by locally adjusting the temperature of the channel waveguide to adjust the refractive index of the channel waveguide.

4. The laser device of claim 1, wherein the laser further comprises a phase control section having one or more electrodes coupled to the channel waveguide of the laser to selectively adjust the refractive index of the channel waveguide.

5. The laser device of claim 4, wherein the phase control section selectively adjusts the refractive index of the channel waveguide by injecting carriers into the channel waveguide.

6. The laser device of claim 1, wherein the feedback portion further comprises one or more heating elements disposed proximate to the optical etalon to adjust the transmission spectrum of the optical etalon by locally adjusting the temperature of the optical etalon.

7. The laser device of claim 1, wherein the laser comprises an optical gain section arranged between the first reflective coating and the feedback portion, and wherein the first reflective coating and the reflective surface of the feedback portion define a single-mode resonance cavity.

8. The laser device of claim 1, wherein
the feedback portion further comprises an optical element arranged to receive and collimate the optical emission from the channel waveguide and provide the collimated optical emission to the optical etalon; and
the reflective surface is arranged to receive optical emission transmitted by the optical etalon and reflect the transmitted optical emission back to the optical etalon.

9. The laser device of claim 1, wherein the transmission spectrum of the optical etalon includes one or more comb-like maxima.

10. The laser device of claim 1, wherein the optical etalon is arranged to provide a wavelength filter for the channel waveguide.

11. A method for tuning a laser device operable in a single-wavelength lasing mode, comprising:
passing an optical emission from a multi-mode laser of the laser device to a feedback portion of the laser device, the laser comprising a channel waveguide, wherein a spectrum of the optical emission peaks at a plurality of discrete wavelengths;
reflecting a portion of the optical emission from the feedback portion to the laser, the feedback portion comprising an optical etalon and a reflective surface, wherein the reflected portion of the optical emission includes the optical emission at one or more maxima transmission wavelengths Of a transmission spectrum of the optical etalon; and
tuning a lasing wavelength of the laser device by locally adjusting a refractive index of the channel waveguide to adjust the spectrum of the optical emission.

12. The method of claim 11, wherein the laser comprises a Fabry-Perot laser.

13. The method claim 11, wherein tuning the lasing wavelength further comprises:
locally adjusting the refractive index of the channel waveguide by adjusting a temperature of the channel waveguide.

14. The method claim 11, wherein tuning the lasing wavelength further comprises:
locally adjusting the refractive index of the channel waveguide by injecting carriers into the channel waveguide.

15. The method claim 11, wherein tuning the lasing wavelength further comprises:
adjusting the refractive index of the channel waveguide to cause the spectrum of the optical emission to overlap transmission spectrum of the optical etalon at the lasing wavelength.

16. The method of claim 11, further comprising:
locally adjusting a temperature of the optical etalon to adjust a refractive index of the optical etalon; and
tuning the lasing wavelength of the laser device by adjusting the refractive index of the optical etalon to adjust the transmission spectrum of the optical etalon.

17. The method claim 16, wherein tuning the lasing wavelength further comprises:
adjusting the refractive index of the optical etalon to cause the transmission spectrum to overlap the spectrum of the optical emission at the lasing wavelength.

18. A laser device operable in a single-wavelength lasing mode at a selectable and tunable lasing wavelength, comprising:
a multi-mode laser comprising a channel waveguide, wherein the laser generates an optical emission having a spectrum that peaks at a plurality of discrete wavelengths;
a feedback portion comprising an optical etalon and a reflective surface arranged to provide wavelength selective feedback to the laser to generate a beam of laser light at a lasing wavelength selected from the plurality of discrete wavelengths; and
a wavelength tuning structure disposed proximate to the optical etalon to provide tuning of the lasing wavelength by locally adjusting a refractive index of the optical etalon to adjust a transmission spectrum of the optical emission,
wherein the wavelength tuning structure adjusts the transmission spectrum of the optical etalon to overlap the spectrum of the optical emission at the lasing wavelength.

19. The laser device of claim 18, wherein the laser comprises a Fabry-Perot laser.

20. The laser device of claim 18, wherein the wavelength tuning structure further comprises one or more heating elements disposed proximate to the optical etalon to adjust the transmission spectrum of the optical etalon by locally adjusting the temperature of the optical etalon.
